(19) United States
(12) Patent Application Publication
(10) Pub. No.: US 2024/0278646 A1
(43) Pub. Date: Aug. 22, 2024

(54) BICYCLE RANGE REMAINING COMPARISON AND VISUALIZATION

(71) Applicant: SRAM, LLC, CHICAGO, IL (US)

(72) Inventors: STEPHEN WINCHELL, BROOKLYN, NY (US); COLE STOLTZFUS, COLORADO SPRINGS, CO (US); BRENT DIMMIG, LANCASTER, PA (US); WILLIAM TRIBBLE, NEW YORK, NY (US); JESSICA BRAUN, AUSTIN, TX (US); SHELBY SESSIONS, CHICAGO, IL (US); MARK SANTURBANE, COLORADO SPRINGS, CO (US)

(73) Assignee: SRAM, LLC, CHICAGO, IL (US)

(21) Appl. No.: 18/437,527

(22) Filed: Feb. 9, 2024

Related U.S. Application Data
(60) Provisional application No. 63/485,645, filed on Feb. 17, 2023.

(51) Int. Cl. B60L 3/12; B60L 50/60; B62J 50/22

(52) U.S. Cl. CPC B60L 3/12; B60L 50/60; B62J 50/22; B60L 2200/12; B60L 2240/60; B60L 2250/16

(57) ABSTRACT

A computer-based method is provided for monitoring bicycle range. The method includes retrieving powered bicycle range data and defining a remaining powered bicycle range at least partially based on the powered bicycle range data. The method then determines or acquires distance to destination data and defines a remaining distance to a destination at least partially based on the distance to destination data. The method then compares the powered bicycle range data or the remaining powered bicycle range to the distance to destination data or the remaining distance to the destination and generates a visualization comparing the powered bicycle range data to the distance to destination data. Also provided is a system for implementing the methods described.

### CROSS REFERENCE TO RELATED APPLICATIONS

This application takes priority from U.S. Provisional Patent Application No. 63/485,645, filed Feb. 17, 2023, the contents of which are incorporated by reference herein.

### FIELD OF THE INVENTION

The present disclosure relates generally to communicating a relationship between an electric bicycle's range and a rider's intended route and/or the rider's power output.

### BACKGROUND

For riders of electric bicycles, or eBikes, understanding the relationship between their eBike battery and their intended route is useful for avoiding running out of eBike battery before completing their bike ride. To date, the relationship between range remaining and the distance an eBike rider intends to ride is difficult to calculate. The understanding of this variable ‘distance delta’ is typically arrived at by way of mental math. That is, mentally subtracting expected range from expected distance remaining.

While some products (including bike computers, phone applications, and smartwatches) offer both values in numeric form, (i.e, range remaining: 27.5 mi/distance remaining: 54.3 mi) these offerings still require arithmetic of the rider, whose attention is best served elsewhere.

Similarly, for riders of eBikes, understanding the relationship between their eBike's motor's power and their own power output is useful for pacing their rides. This is particularly true when riding with other cyclists. To date, the relationship between eBike power and rider power is difficult to calculate. The understanding of this variable ‘power delta’ is arrived at by way of mental math. That is, subtracting eBike motor power from rider power.

While some products (including bike computers, phone applications, and smartwatches) offer both values in numeric form, (i.e., eBike power: 103 W/rider power: 247 W), these offerings still require arithmetic of the rider, whose attention is best served elsewhere.

There is a need for methods and systems for displaying to users an easily digestible visualization that allows the user to evaluate remaining electric bicycle range in terms of a remaining distance to a destination and/or electric motor power output in the context of their own rider specific power output.

There is a further need for such methods and systems that provide mechanisms for presenting suggestions and providing mechanisms for increasing remaining electric bicycle range upon determining that such range is insufficient.

### SUMMARY

Embodiments described herein are designed to reduce the time and effort required for the rider to come to a suitable understanding of the relationship between the range remaining in their eBike and the distance left to navigate to their destination.

Other embodiments described herein are designed to reduce the time and effort required for the rider to come to a suitable understanding of the relationship between a rider's power output and the eBike's motor's power.

Other embodiments described herein are designed to assist the rider in maintaining sufficient eBike range to reach their destination.

In some embodiments, a computer-based method is provided for monitoring bicycle range. The method includes retrieving powered bicycle range data and defining a remaining powered bicycle range at least partially based on the powered bicycle range data. The method then determines or acquires distance to destination data and defines a remaining distance to a destination at least partially based on the distance to destination data.

The method then compares the powered bicycle range data or the remaining powered bicycle range to the distance to destination data or the remaining distance to the destination and generates a visualization comparing the powered bicycle range data to the distance to destination data.

In some such embodiments, the method displays an indication upon determining that the remaining powered bicycle range represented by the bicycle range data is less than the remaining distance to the destination represented in the distance to destination data. In some such embodiments, the indication is the presentation of the visualization generated to a user or a display or color change of a user interface element in the context of the visualization.

In some embodiments, the visualization generated presents a first user interface element with a characteristic based on the bicycle range data and a second user interface element with a characteristic based on the distance to destination data, and the characteristic of the first user interface element is a size characteristic proportional to the remaining bicycle range and the characteristic of the second user interface element is a size characteristic proportional to the distance to the destination.

In some embodiments, the visualization generated includes a map presenting hypothetical destinations, wherein the method further comprises highlighting all destinations of the hypothetical destinations within the remaining powered bicycle range.

In some embodiments, the distance to destination data is based on a predefined destination, and the method retrieves or determines a current location of a device implementing the method and calculates a distance to the predefined destination based on a mapping module and provides a result as the remaining distance.

In some such embodiments, the powered bicycle range data is based at least partially on a grade or surface texture of at least a segment of a route defined by the mapping module, equipment factors associated with a bicycle utilized for implementing the method, environmental conditions at a location of the bicycle, or hardware factors associated with a drive unit or battery utilized by the bicycle.

In some such embodiments, the remaining distance is based on a primary route, and the remaining powered bicycle range is based on the powered bicycle range data. The method then further comprises defining and evaluating at least one alternative route based on alternative powered bicycle range data associated with the alternative route and defined by the mapping module. The method then generates a recommendation of the alternative route upon determining that the alternative powered bicycle range data generates an alternative remaining powered bicycle range value that is either larger than that of the powered bicycle range data or represents a larger percentage of the alternative route than the remaining powered bicycle range represents of the primary route.

In some embodiments in which a destination is predefined, the remaining powered bicycle range is based at least partially on a first assist mode of a drive unit associated with a bicycle utilized for implementing the method selected from a plurality of potential assist modes.

In some such embodiments, upon determining that the remaining powered bicycle range is less than the remaining distance to a destination, the method transitions the drive unit to a second assist mode of the plurality of potential assist modes different from the first assist mode, where the second assist mode provides reduced motor output relative to the first assist mode.

In some embodiments, a destination is inferred based on a likely travel path, and the powered bicycle range data is then based on the likely travel path.

In some embodiments, the remaining powered bicycle range is a projection based at least partially on an amount of power remaining combined with a projected contribution of rider power, such that the remaining powered bicycle range is greater than a battery only powered bicycle range.

In some such embodiments, the projected contribution of rider power assumes a continuing contribution from a user based on a rolling average over a period of time prior to the retrieving of powered bicycle range data.

In some such embodiments, the method displays an indication upon determining that the remaining powered bicycle range represented by the powered bicycle range data is less than the distance to the destination represented by the distance to destination data. The method then repeatedly retrieves updated powered bicycle range data and determines or acquires updated distance to destination data, and the updated powered bicycle range data is based on a different period of time prior to the retrieving, such that the indication depends on an updated projected contribution of rider power.

In some embodiments, the projected contribution of rider power is based at least partially on biometric data of a rider.

In some embodiments the projected contribution of rider power is based at least partially on historical data based on historical bicycle riders in comparable riding scenarios. In some such embodiments, the historical data based on historical bicycle riders is normalized based on biometric data of a rider using the computer-based method.

In some embodiments, a system is provided for implementing the various methods described herein. Such a system includes a user interface device having a processor, a communication module, and a display, the user interface device being mounted on a bicycle. Such a system further includes an energy storage device mounted on the bicycle, the energy storage device having a communication module in communication with the communication module of the user interface device.

Such a system further includes a drive unit mounted on the bicycle and powered by the energy storage device, such that the drive unit applies a motive force to propel the bicycle using energy from the energy storage device.

The user interface device retrieves from the energy storage device powered bicycle range data and determines a remaining powered bicycle range based on the bicycle range data. The user interface device then determines or acquires distance to destination data representing a remaining distance to a destination.

The user interface device then compares the powered bicycle range data to the distance to destination data and generates a visualization comparing the powered bicycle range data to the distance to destination data.

In some such embodiments, the communication module of the user interface device and the communication module of the energy storage module are in wireless communication.

In some embodiments of the system, the drive unit has a first configuration utilizing a first of a plurality of assist modes, and the remaining powered bicycle range is based at least partially on the configuration of the drive unit. Upon determining that the remaining bicycle range is less than the remaining distance to destination, the user interface device may then transmit an instruction to the drive unit by way of the communication module to transition the drive unit to a second configuration utilizing a second of the plurality of assist modes, wherein the second assist mode provides reduced motive force relative to the first assist mode.

### BRIEF DESCRIPTION OF THE DRAWINGS

FIG. 1 is a side view of a bicycle providing context for use in implementing the systems and methods of this disclosure.

FIG. 2 is a side view of a bicycle frame with an energy storage device and drive unit mounted thereon.

FIG. 3 is a sectioned view of the energy storage device and drive unit of FIG. 2.

FIG. 4 is a side perspective view of the energy storage device of FIG. 2.

FIG. 5 shows a PCB incorporated into the energy storage device of FIG. 2.

FIG. 6 is a block diagram illustrating an embodiment of an energy storage device for use in accordance with this disclosure.

FIG. 7 shows a schematic representation of a user interface device for use in implementing a method in accordance with this disclosure.

FIG. 8A is a flowchart illustrating a method for monitoring bicycle range in accordance with this disclosure.

FIG. 8B shows a schematic representation of a relationship between a user interface device and data sources for use in the method of FIG. 8A.

FIG. 8C shows a schematic representation of a relationship between a user interface device and system components for use in the method of FIG. 8A.

FIGS. 9A-C illustrate visualizations generated by the method of FIG. 8A.

FIG. 10 is a flowchart illustrating a method for monitoring bicycle power output in accordance with this disclosure.

FIGS. 11A-C illustrate visualizations generated by the method of FIG. 10.

FIGS. 12A and 12B illustrate an alternative visualization generated by the methods of FIG. 8A.

FIG. 13 shows a user interface device implementing a portion of the method of FIG. 8A.

FIG. 14 shows a user interface device implementing a portion of the method of FIG. 8A.

FIG. 15 illustrates a method for modifying hardware system settings in the context of the method of FIG. 8A.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention.

The term “communicating” refers to a connection allowing for the transfer of power and/or data, and may include a wired or wireless connection. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components.

Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. The terms may refer to an electrical or mechanical connection.

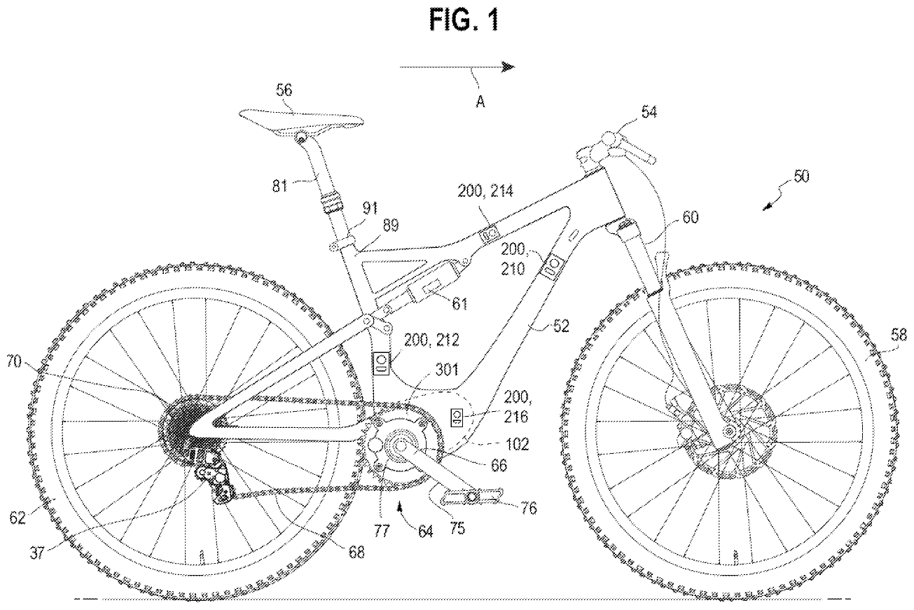

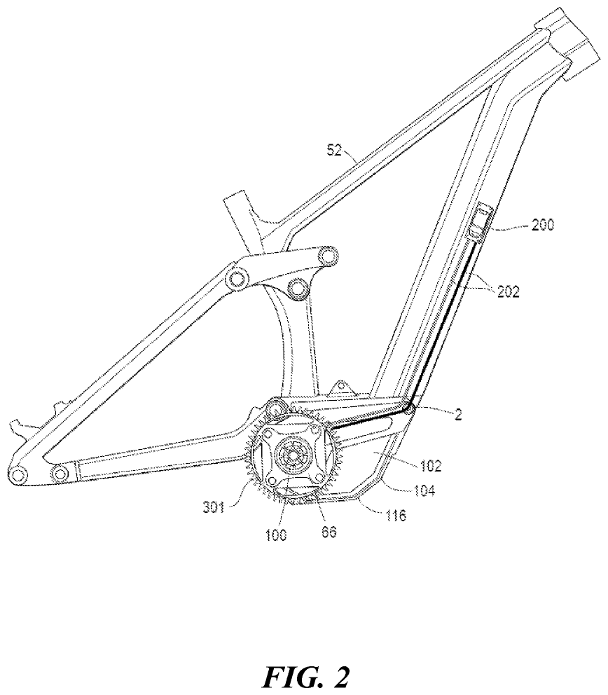

Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto. Accordingly, in the context of FIG. 1, the terms “upper,” “lower,” “rear,” “front,” “fore,” “aft,” “vertical,” “horizontal,” “right,” “left,” “inboard,” “outboard” and variations or derivatives thereof, refer to the orientations of an exemplary bicycle 50, shown in FIG. 1, from the perspective of a user seated thereon, for example with an “inboard” component or feature being closer to a vertical mid-plane of the bicycle extending in a direction A. The term “transverse” means non-parallel. The terms “outer” and “outwardly” refers to a direction or feature facing away from a centralized location, for example the phrases “radially outwardly,” “radial direction” and/or derivatives thereof, refer to a feature diverging away from a centralized location, for example a rotation axis 2 of a bash guard as shown in FIG. 2. Conversely, the terms “inward” and “inwardly” refers to a direction facing toward the centralized or interior location. The term “subassembly” refers to an assembly of a plurality of components, with subassemblies capable of being further assembled into other subassemblies and/or a final assembly, such as the bicycle 50.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

While riding and utilizing a user interface device mounted on a bicycle and implementing methods disclosed herein, subsequent updates to a rider's position from a position determining module, such as GPS, can be used to calculate and thereby determine a remaining distance to a destination. The user interface device may separately retrieve information regarding remaining powered bicycle range from an energy storage device mounted on the bicycle and in communication with the user interface device, and such data can be used in generating a visualization for display.

Similarly, the user interface device may retrieve information regarding rider specific power output from sensors associated with the energy storage device or a drive unit mounted on the bicycle. The user interface device may similarly retrieve information regarding motor output power from the energy storage device or drive unit, and such data may be used in generating a visualization for display.

FIG. 1 shows a side view of a human powered vehicle, namely a bicycle 50, providing context for use in implementing the systems and methods of this disclosure. The human powered vehicle also provides a powered drive system, such as an electrically powered drive system, as shown in the following drawings.

In this example, the vehicle is one possible type of bicycle 50, such as a mountain bicycle. The bicycle 50 has a frame 52, handlebars 54 near a front end of the frame 52, and a seat or saddle 56 for supporting a rider over a top of the frame 52. The bicycle 50 also has a first or front wheel 58 carried by a front fork subassembly 60 supporting the front end of the frame 52. The bicycle 50 also has a second or rear wheel 62 supporting a rear end of the frame 52. The rear end of the frame 52 may be supported by a rear suspension component 61, such as a rear shock. The bicycle 50 has a drive train 64 with a crank assembly 66 that is operatively coupled via a roller chain 68 to a rear cassette 70 or a driven sprocket assembly near the hub providing a rotation axis of the rear wheel 62. The crank assembly 66 includes at least one, and typically two, crank arms 75 and pedals 76, along with a front chainring assembly 301 or a drive sprocket assembly. A crank spindle or shaft may connect the two crank arms. The crank shaft defines a center rotational axis of the chainring assembly 301. The crank assembly may also include other components.

A rear gear change device 37, such as a derailleur, is disposed at the rear wheel 62 to move the roller chain 68 through different sprockets of the cassette 70. In one embodiment, a front gear changer device (not shown), such as a derailleur, may be provided to move the chain 68 through multiple sprockets of the chainring assembly 301, if present. In the illustrated example, the saddle 56 is supported on a seat post 81 having an end portion received in a top of a frame seat tube 89 of the frame. A clamping ring 91 may be tightened to secure the upper seat post 81 to the lower frame seat tube 89. In FIG. 1, the arrow A depicts a normal riding or forward moving direction of the bicycle 50.

In some embodiments, a user interface device 700, occasionally referred to herein as a head unit or a cycling computer, is provided and may be mounted at a handlebar. Such a device may be a cycling computer, and may be used to track various characteristics of the rider's usage of the bicycle 50, as discussed in more detail below.

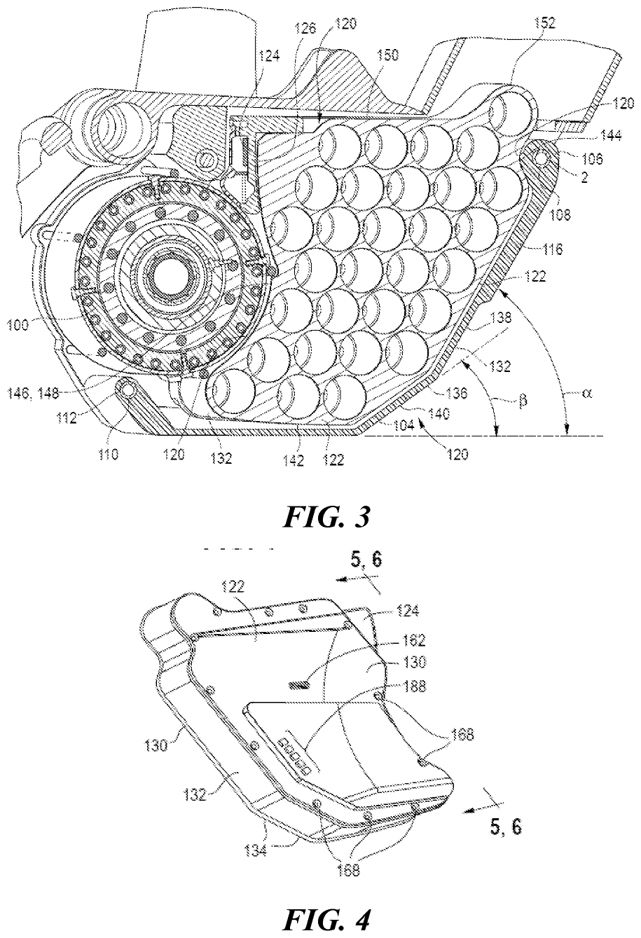

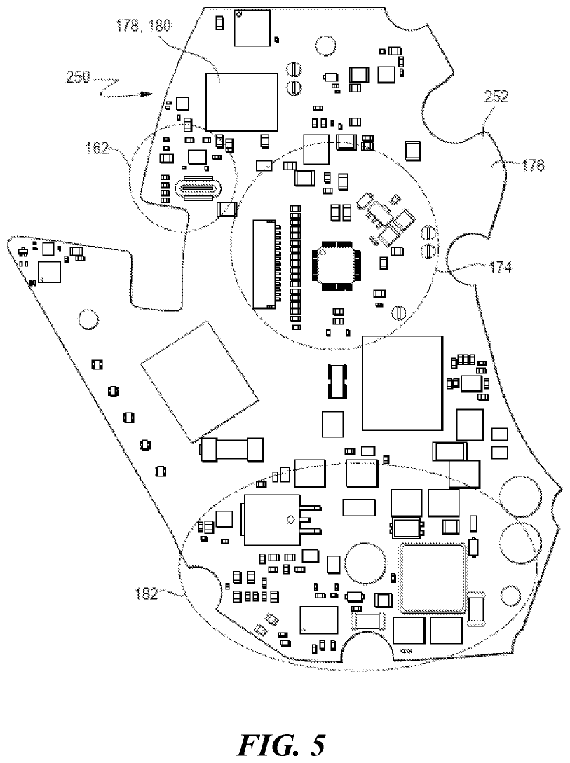

FIG. 2 is a side view of a bicycle frame 52 with an energy storage device 102, sometimes referred to herein as a battery, and drive unit 100 mounted thereon. FIG. 3 is a sectioned view of the energy storage device 102 shown in FIG. 2. FIG. 4 is a perspective view of the energy storage device 102 of FIG. 2. The drive train may be configured with a power meter device 77, as shown in FIG. 1. Such a power meter device 77 may output data representing power applied by a user at the crank arms 65. When a drive unit 100 is used, as shown in FIG. 2, to drive the crank assembly 66, the data generated and output by the power meter device 77 may represent total power applied to the crank assembly by both the user and the drive unit. Alternatively, the power meter device 77 may be configured to output data representing power applied by a rider regardless of the power independently applied by the drive unit 100.

In the embodiment shown in FIG. 2, the power meter device 77 is removed in favor of alternative sensors integrated into the drive unit 100 mounted on the bicycle frame 52. However, such alternative sensors may similarly measure force applied by the rider and the drive unit 100, either independently or in combination.

As shown, the bicycle 50 includes a drive unit 100 mounted on the frame 52 and coupled to the crank assembly 66. The drive unit 100 may be powered to assist, partially or entirely, with the rotation of the crank assembly 66, the associated movement of the chain 68, and the associated rotation of the cassette 70 and rear wheel 62. The drive unit 100 may be electrically coupled to an energy storage device 102, otherwise referred to as a battery, which supplies power to the drive unit 100.

The energy storage device 102 is held in place by an upper contact 126 engaging a drive unit battery contact connection 124, and a bash guard 104 mounted to the frame 52 at a mounting feature 106, configured as a lug in one embodiment. The mounting feature 106 of the bash guard 104 defines a rotation axis 2 and includes an opening that receives a fastener 108 (e.g., pin or shaft), which secures the mounting feature to the frame 52. The bash guard 104 incudes a detent feature that engages the energy storage device. The bash guard 104 may rotate around the axis 2. The bash guard 104 includes a second mounting feature 110, configured as a lug in one embodiment, which is further connected to the frame 52 at a second connection point, defined by a releasable, or removeable fastener 112. In one embodiment, the fastener 112 is configured as a pin, which may be inserted through an opening in the mounting feature 110 in the bash guard 104 and engaged with corresponding openings located on the bicycle frame 52 or drive unit 100. The fastener 112 may be removed, such that the bash guard 104 may be rotated about the axis 2 and thereby lowered. The bash guard 104 includes a plate/support structure 116 extending between the mounting features 106, 110.

The energy storage device 102 may be disposed on the bash guard 104, or engaged therewith, for example by nesting the energy storage device 102 on the plate/support structure 116. The energy storage device 102 and bash guard 104 may thereafter be rotated in an opposite direction about the axis 2 until the battery contact connection 124 on the energy storage device 102 contacts, and is engaged by, the corresponding contact 126 on the drive unit, or frame 52, which may be defined by a pair of prongs. The fastener 112 may then be inserted to fix the location of the energy storage device 102 and bash guard 104 relative to the frame 52 and drive unit 100, while maintaining the electrical connection between the drive unit 100 and energy storage device 102 through the contact connection 124 and contact 126.

In this way, the energy storage device 102 is held in place relative to the frame 52 and drive unit 100 by a mounting arrangement 120. The mounting arrangement 120 may be defined by the shape of an energy storage device housing 122 and the interface between the housing 122, the bash guard 104, frame 52 and/or drive unit 100. The phrase “mounting arrangement” refers to any structure that maintains the position of the energy storage device 102 relative to the frame 52 and/or drive unit 100, and may include the interface between the housing 122 and the frame 52 and/or drive unit 100, including the interface between the contacts 124, 126, and/or may include additional fasteners, such as bolts, tabs, clips, snaps, detents, insert/socket interfaces and/or other suitable connectors. The energy storage device 102, and the housing 122 in particular, is releasably connected to the frame 52 and/or drive unit 100, meaning the energy storage device 102 and housing 122 may be moved from an engaged position to a disengaged position, and may be replaced with another energy storage device.

As shown in FIGS. 3 and 4, the housing 122 may be configured with a pair of laterally spaced apart opposite sidewalls 130, or covers, and a peripheral wall 132 extending between and connected to the sidewalls 130. One or more of the peripheral wall 132 and sidewalls 130 may define a shell, which is covered by the other sidewall, with the other of the sidewalls 130 and peripheral wall 132 each defining a cover. The sidewalls 130 have an outer edge 134 that generally mates with, or follows the contour of the peripheral wall 132. As shown for example in FIG. 3, the outer edges 134 and peripheral wall 132 have a front face 136 having an upper portion 138 and a lower portion 140 forming a first acute angle α and a second acute angle β relative to a bottom face 142. The front face 136 further includes a concave recess 144 or socket, that receives the mounting feature 106 of the bash guard 104, which is nested in the recess 144 that defines in part the mounting arrangement 120 of the energy storage device 102. The bottom face 142 extends rearwardly from the lower portion 140 of the front face 136. The housing 122 further includes a rear face 146 extending upwardly from the bottom face 142. The rear face 146 includes a second concave recess 148 that receives an outer periphery of the drive unit 100, which is nested in the second recess 148 that defines in part the mounting arrangement 120 of the energy storage device 102. A top face 150 of the peripheral wall 132 extends forwardly from the rear face 146 and is connected to the front face 136 at a protruding corner 152.

The housing 122 includes a charging portion 154, or platform, which protrudes or extends from the peripheral wall and has a width less than the overall width of the peripheral wall. The charging portion 154 may be integrally formed with the peripheral wall, and may include one or more charge ports (not shown). The battery contact connection 124 is then located on, and defines in part, a rear face portion of the charging portion 154, and may be defined by the charge ports. In some embodiments, a first charge port is configured as a DC charge port, including for example a pair of electrical contacts, and a second charge port is configured as a USB C charge port. The charge ports may be co-located, for example on the same mounting plate, which may be a removeable cover secured to the charging portion 154. Alternatively, one or both of the charge ports may be spaced apart and located on different parts of the housing, for example on one of the sidewalls 130. For example, as shown in FIG. 4, the second charge port 162, configured as the USB C charge port, is located on an outer side wall 130, and the first charge port is then separately located on the mounting plate 164. It should be understood that the charge ports may be located, separately or together, on any portion of the housing.

The sidewalls 130 and peripheral wall 132 define an interior cavity of the housing 122. The sidewalls 130 may be attached to the peripheral wall 132 with a plurality of fasteners 168 shown as screws, or may be integrally formed therewith or connected with other fasteners, such as adhesive, snap-fit, tabs, clips and/or other suitable fasteners.

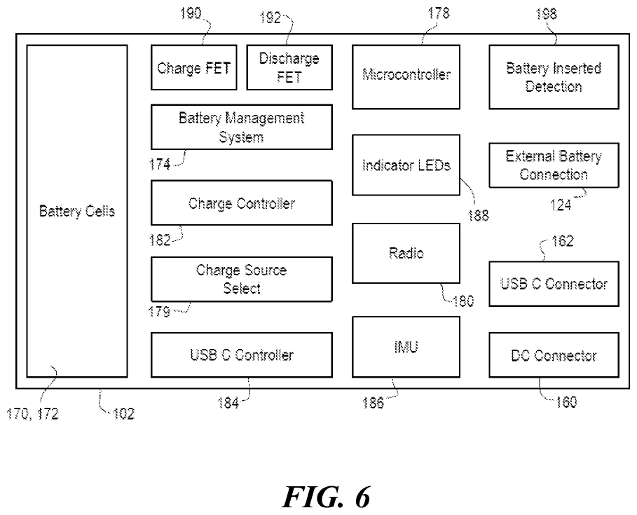

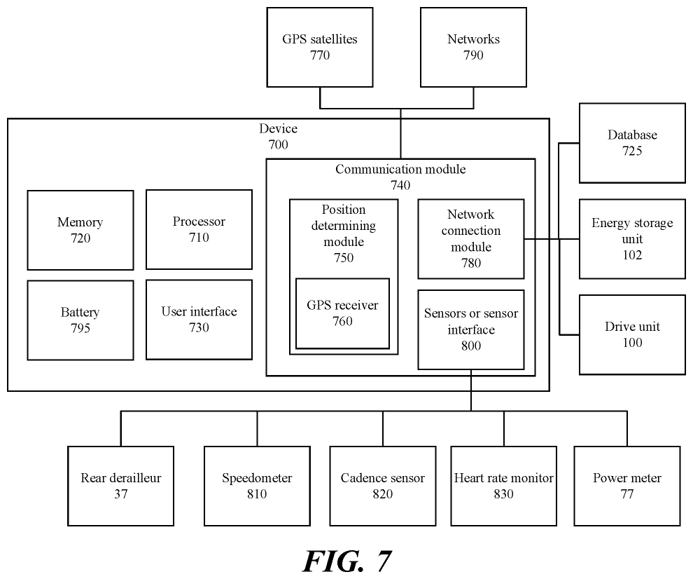

The energy storage device 102 typically includes a battery pack 172, which may take various configurations, as well as control circuitry for controlling behaviors of the battery pack during use for charging and discharging. FIG. 5 shows a printed circuit board (PCB) 176 incorporated into the energy storage device 102 of FIG. 2. FIG. 6 is a block diagram illustrating the energy storage device 102 of FIG. 2 schematically. The energy storage device 102 includes a battery management system (BMS) 174 disposed in the housing 122. The BMS 174 may be mounted on a printed circuit board (PCB) 176 disposed in the housing. The PCB 176 overlies and has a connector that is plugged into the PCB from the battery cells 170. The PCB 176 is typically disposed or mounted in the interior of the housing 122. The BMS 174 connects to each series set of cells 170 in the battery pack 172 to monitor the voltage of cells for faults. The BMS 174 also measures the current into and out of the battery pack 172 to protect against over current faults. The BMS 174 may include temperature sensors that are distributed throughout the battery pack to monitor the temperature of the battery pack 172 during charge and discharge to prevent damage to the battery pack due to overheating. Using all of this information, the BMS 174 may control charge and discharge field-effect transistors (FETS) 190, 192 to either connect or disconnect the battery pack 172 from the rest of the system during charge and discharge. The BMS 174 receives configuration information from a microcontroller 178 and radio 180. Configuration information may include charge/discharge current limits, individual cell voltage limits, and over/under temperature limits, which may be preset by the microcontroller firmware. The configuration information may also be updated via a firmware update or dynamically based on information received by the microcontroller 178 from other systems on the bicycle, received for example wirelessly by the radio.

The energy storage device 102 includes a charge controller 182 disposed in the housing 122, and mounted on the PCB 176. The charge controller 182 may be connected to a DC power source. The charge controller 182 modulates the DC power to safely charge the battery pack 172. In the case of a lithium-ion battery pack, the charge controller 182 supplies a constant current to the battery cells 170 until a target voltage is reached, then the charge controller supplies constant voltage while the current slowly goes down to zero. During charging the charge controller 182 communicates with and receives messages from the battery management system 174 and the microcontroller 178, such that the charge controller may modulate the charge current to provide a fast and safe charge based on the state of the battery.

The microcontroller 178 may be disposed in the housing 122, or interior cavity thereof, and mounted on the PCB 176. The microcontroller 178 receives data from the BMS 174, in some embodiments, a USB C controller, the charge controller 182, and any other connected sensors and devices. Such sensors may include an inertial measurement unit (IMU) 186, and such devices may be a smartphone having a smartphone app connected via wireless or wired communication. The microcontroller 178 uses the data to make determinations about how fast to charge the battery pack 172, how much power to supply from the USB C charge port 162, if connected, whether the energy storage device 102 has been dropped when not installed in the bicycle, when to display battery state of charge with indicators (e.g., LED's), and/or when to enable the output of the energy storage device 102. A smartphone app may receive information about the energy storage device 102 via the microcontroller 178 and radio 180. Some of the information that may be transmitted to the user, or human/machine interface (HMI) 700, otherwise referred to as a user interface, such as a smart phone or cycling computer, may be the state of charge, estimated time to charge, faults, temperature of the battery pack, voltages of individual cells, total battery pack voltage, and the health of battery pack. The smartphone app may also transmit information to the battery pack.

Further, as discussed below, the user interface device 700 may receive information from the energy storage device 102 during use. Such information may include, for example, a measure of remaining energy in the energy storage device or a measure of remaining powered range for the drive unit 100 when powered by the energy storage device. In some embodiments, the microcontroller 178 may manage information retrieved from and transmitted to the drive unit 100 as well. Accordingly, the microcontroller may manage and the radio 180 may transmit information related to motor power output during use as well as rider generated power retrieved from, e.g., a power meter device 77 integrated into the bicycle 50 or into the drive unit 100 or energy storage device 102.

The energy storage device may also include indicators 188, configured in one embodiment as an array of LEDs mounted on the PCB 176, with the LEDs being visible to a user through or on the exterior of the housing. The indicators 188 may be a collection of red/blue/green (RGB) LEDs that may be used to display the state of charge, error messages, or general bicycle alerts. The LED's may be activated depending on whether the energy storage device 102 has been installed, via a battery installation detection device 198, or by the IMU 186. Indications may also be transmitted to the user via the smartphone app or via the user interface device 700. A push notification for faults may alert the user in more detail of what has caused the energy storage device 102 to fail. Inside the app, battery state of charge and health may be displayed on the component screen. In one embodiment, a plurality of indicators 188 are provided, including for example five (5) RGB LEDs, to provide various indications. There are several potential ways that these LEDs may be used to indicate state of charge and faults to the user. For example, a state of charge (SOC) indication may be provided when the energy storage device 102 is not installed into the bicycle, and may be triggered for example when the energy storage device 102 is picked up or otherwise moved, with the movement being detected by the IMU 186.

The indicators 188 may be used by using only green LEDs and decreasing the brightness as state of charge decreases. For example, if there are five (5) LEDs, then each LED may turn off after another 20% state of charge has been consumed by the system. Within each 20%, the LED brightness would decrease from 100% to 0%. Alternatively, the indicators 188 may be configured as RGB LEDs, which change from Green to Orange to Red within each 20% of SOC. Faults may be indicated by lighting up specific LEDs or patterns of LEDs in a way that does not look like an SOC indication. For example, a single Red LED may be illuminated in a position that SOC could never indicate. Different positions may indicate different types of faults. Flashing LEDs in a pattern may indicate different faults based on timing and color.

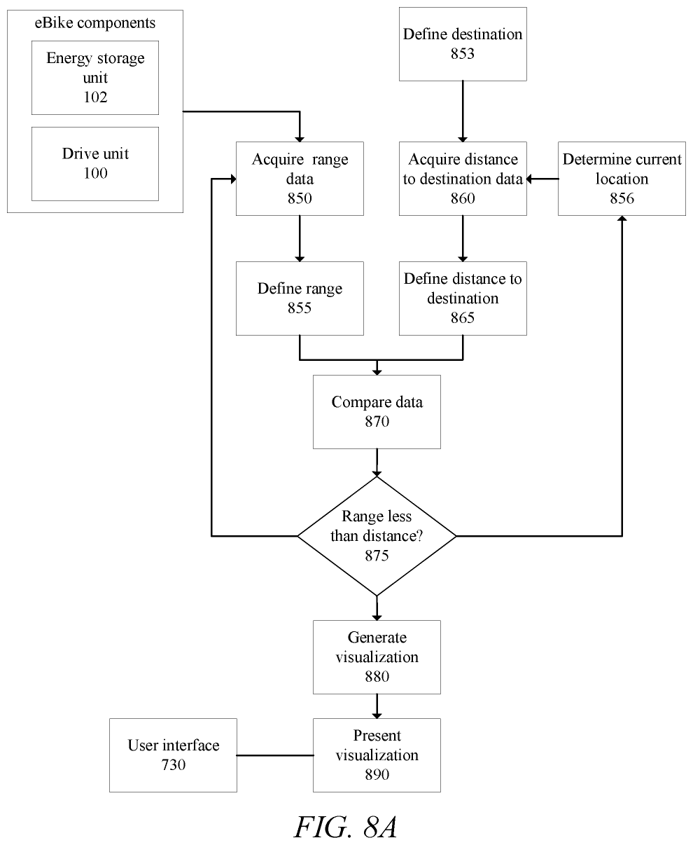

FIG. 7 shows a schematic representation of a user interface device 700 for implementing the methods described herein while in communication with at least one of the energy storage device 102 and the drive unit 100 discussed above. In the embodiments discussed, the device 700 is generally a cycling computer head unit or other navigation device, and is referred to herein as such, and is operable to provide navigation functionality to a cyclist. However, the device 700 may similarly be a device designed for other activities, such as cycling or driving, or it may be a general-purpose smartphone having navigation applications. Further, in some embodiments, the device 700 may be a dedicated position determining device provided with features sufficient to implement the methods described herein.

The device 700 is provided with a processor 710 and a memory 720. The processor 710 includes processing circuitry and provides processing functionality for the device 700, and may include any number of processors, micro-controllers, or other processing systems. The processor 710 may be formed from a variety of materials and components, and may execute the methods described herein.

The memory 720 may provide storage functionality, and may store various instructions and data associated with the operation of the device 710. Such instructions and data may include software programs for implementing the methods described herein, as well as data for supporting such software programs.

The memory 720 may be integral with or independent of the processor 710, and may take a wide variety of forms. For example, the memory may be non-removable memory elements, such as RAM, as well as ROM, Flash (such as removable memory cards), magnetic media, optical media, USB devices, and others. Data for use in the methods described herein may be provided at the memory 720 or may be provided independently in a database 725. However, data described herein as being stored in a database 725 can similarly be provided within the memory 720 itself. Such data may include the instructions for operating an application implementing the methods described herein, as well as data for supporting such methods, such as mapping data and metadata, among other data.

The device 700 is further provided with a user interface 730 through which a user interacts with the device. Such a user interface 730 may be, for example, a touch screen through which the user may enter commands and receive feedback. Such a touch screen may display maps and present the output of the interface features discussed herein. The user interface 730 may include buttons instead of or in addition to touch-based features in the display, and the user interface may similarly include a display independent of any user control. For example, in the case of a cycling computer 700, a user may control the device by way of speech recognition software, or a user may control the device by buttons mounted on handlebars instead of at the device 700 itself. Similarly, the user interface 730 may be configured to incorporate gesture-based controls. The display may be any of a wide variety of standard displays, including LCD, LED, and any other type of display. The display is typically configured to present text and/or graphical information to the user.

Typically, applications implementing the methods described herein are stored in memory 720 and are executed by the processor 710. Such applications implement software user interfaces and users interact with the applications by way of the device 700 user interface 730.

The device 700 also provides a communication module 740 for providing access to devices and data sources independent of the device itself. The communication module 740 includes a position determining module 750, which typically takes the form of a GPS receiver 760, as discussed above. The position determining module 750 may then receive signal data transmitted by one or more external data sources, typically GPS satellites 770. While GPS satellites 770 are illustrated, position data for geolocating the device 700 may take a wide variety of forms, such as positioning beacons for triangulating the device. In any event, the position determining module 750 is operable to determine a position through processing of data received from an external data source, such as geolocation utilizing GPS satellites 770.

Typically, the position determining module 750 provides data to the processor 710 which may then be used to implement a wide variety of basic features, including the illustration of a location on a map drawn from the memory 720. Similarly, the data may be used to determine a velocity and/or direction of movement for a user of the device, as discussed in more detail below.

The communication module 740 may further include a network connection module 780 for interfacing with an external network 790 or database 725 as well as to send or receive information to a second iteration of the device 700 or a different device, such as the energy storage device 102 or the drive unit 100 discussed above. Similarly, the network connection module 780 may allow the device 700 to interface with a user's smartphone. The network communication module 780 may include a transceiver as well as components for operating the transceiver, such as one or more antennas, a wireless radio, data ports, and any required software interface for implementing communication protocols utilized by the network communication module 780. The external network 790 may be a localized network and may be accessed by way of Wi-Fi or Bluetooth protocols, or it may be the internet accessed by way of a cellular provider, for example. In some embodiments, the device 700 networks with a user's smartphone by way of a Wi-Fi or Bluetooth connection and accesses the internet by way of the user's smartphone. It is noted that while the device 700 is discussed as networking with other devices by way of a wireless antenna, a network in the context of a specific bicycle 50 may be formed by way of a wired connection.

In some embodiments, the device 700 supports an electric bicycle, or eBike, such as the energy storage device 102 or the drive unit 100 broadcasting its “range remaining” metric over a standardized format. For example, the eBike components may broadcast over the Light Electric Vehicle profile of the ANT+ radio signal or a Bluetooth radio signal. In this way, the eBike components may be paired with the device 700 and utilized as data sources in the various ways discussed below.

A battery 795 is provided in order to provide power to the other components of the device 700. Such a battery 795 may be built into the device 700 and rechargeable or it may be removable for charging outside of the device or for replacement.

The device 700 may provide at least one sensor or sensor interface 800 for interfacing with external sensors. Such sensor interfaces 800 may allow the device to receive data from peripheral sensors, such as a speedometer 810, cadence sensor 820, heart rate monitor 830, a power meter device 77, the energy storage device 102, and others. For example, the sensor interface 800 or network communication module 780 may allow for communication with other data enabled bicycle components, such as a rear derailleur 37, in order to acquire additional data related to a state of the bicycle as a whole. Such sensor interfaces 800 may be wired or wireless. It will be understood that sensors may be integrated into the device 700 as well, such as inertial sensors including accelerometers, directional sensors, such as a compass, and general orientation sensor. Such sensors, both internal to the device 700 and connected by way of the sensor interfaces 800, may support independent features of the device 700 as well as provide additional data by which the device 700 can infer, e.g., location and directionality. It is noted that devices may be interchangeably connected by way of the network connection module 780 and the sensor interface 800, as both interfaces are interfaces by which the device 700 can acquire data.

Accordingly, the various components described herein may be utilized in a system for implementing the methods described herein. Such a system may include the user interface device 700 having a processor 710, a communication module 740, and a display, such as a user interface 730. The user interface device 700 may be, e.g., a head unit for a bicycle computer, and may be mounted on a bicycle 50.

The system further includes an energy storage device 102 mounted on the bicycle, which includes a communication module or interface 840 in communication with the communication module 740 of the user interface device 700.

The system further includes a drive unit 100 mounted on the bicycle 50 and powered by the energy storage device 102. The drive unit 100 applies a motive force to propel the bicycle 50 using energy from the energy storage device 102.

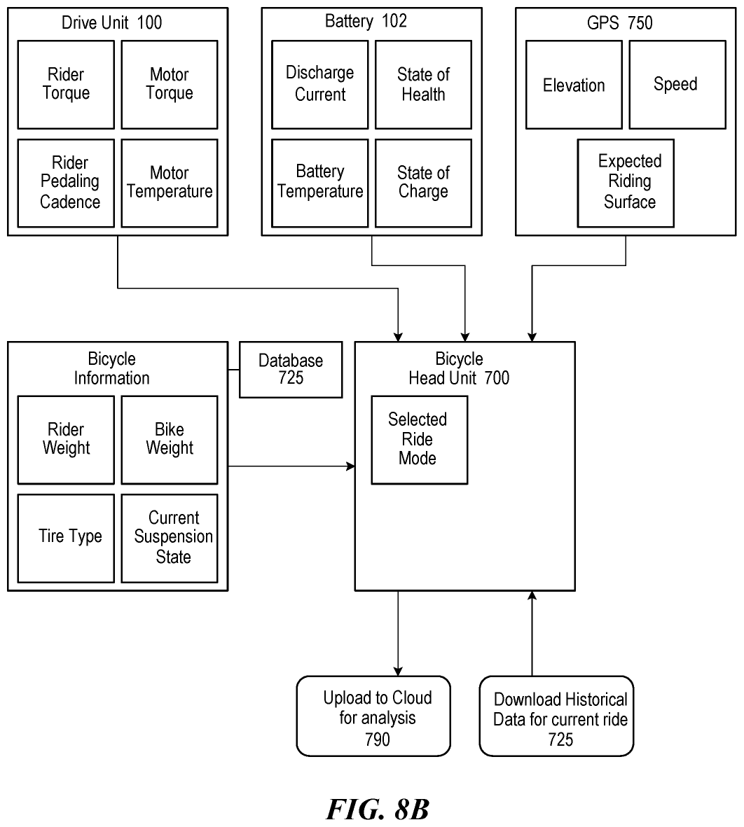

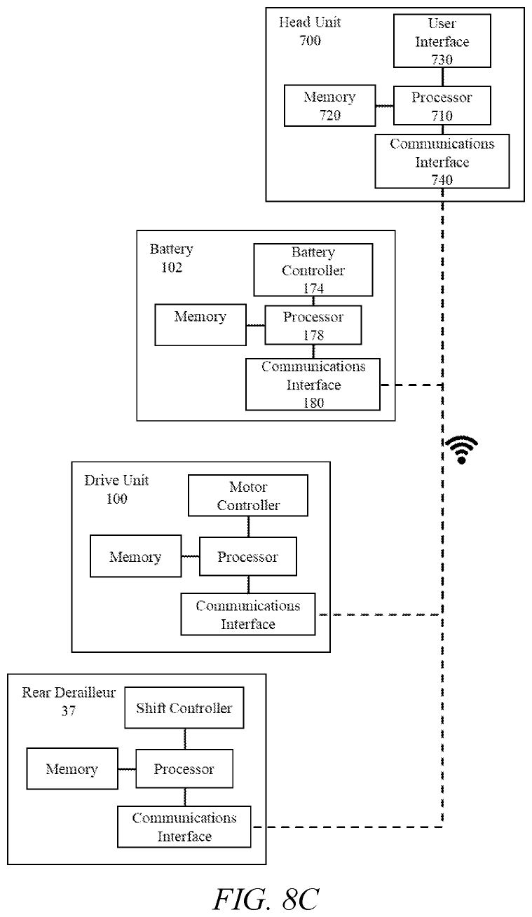

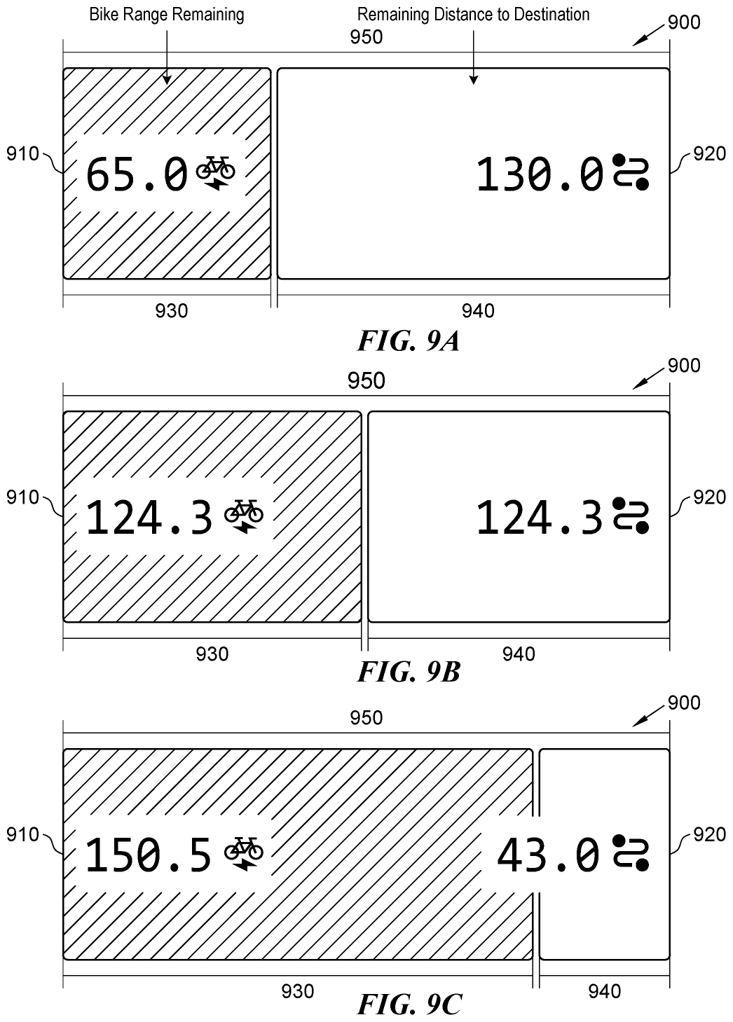

FIG. 8A is a flowchart illustrating a method for monitoring bicycle range in accordance with this disclosure. FIG. 8B shows a schematic representation of a relationship between a user interface device 700 and various potential data sources for use in the method of FIG. 8A and FIG. 8C shows a schematic representation of a relationship between a user interface device 700 and system components for use in the method of FIG. 8A.

The computer-based method is typically implemented at the device 700, and data is retrieved by way of either the network connection module 780 or the sensor interfaces 800. As such, and as shown in FIGS. 7 and 8B, when data is retrieved, it is typically retrieved from, e.g., the energy storage device 102 or the drive unit 100. However, in certain implementations, additional data may be retrieved from a database 725, various sensors, 37, 77, 810, 820, or 830, or a GPS module 770. As shown in FIG. 8C, the various components may be connected by a wired or wireless network, and in some embodiments, communication may be enabled in both directions, such that the head unit 700 may retrieve data from various system components and sensors, and the head unit 700 can also transmit messages to, e.g., the drive unit 100 or the battery 102 in order to implement modifications or change settings.

As shown, the computer-based method begins by retrieving powered bicycle range data (850). The powered bicycle range data typically includes data retrieved from the energy storage device 102 by way of the network connection module 780. Such data represents a remaining powered bicycle range. However, as is discussed in more detail below, the bicycle range data (retrieved at 850) may contain data in addition to battery data retrieved from energy storage device 102, and additional data may be considered in defining a remaining powered bicycle range utilizing the powered bicycle range data. Accordingly, in some embodiments, the retrieval of range data (at 850) and the determination of a remaining powered bicycle range (at 855) may be discrete steps implemented by the method such that the method initially retrieves the range data and then defines the remaining powered bicycle range at least partially based on the range data.

The method then separately determines or acquires distance to destination data (860), which represents, or is used to define, a remaining distance to a destination (at 865). Such data may be contained in an onboard memory 720 or may be acquired from an external device, such as a smartphone. In the embodiment shown, the device 700 is a cycling computer and typically includes a position determining module 750, and may be utilized to map a route. Accordingly, in the embodiment shown, the device 700 may determine the distance to destination data (at 860) internally, such that it does not rely on an external device. Accordingly, the distance to the destination may be a distance along a defined route. The remaining distance to a destination may then be defined (at 865) at least partially based on the determined or acquired distance to destination data.

In some embodiments, the bicycle range data 850 may comprise data retrieved from a variety of sources, and the definition of a remaining powered bicycle range (at 855) from that data may require additional analytical steps. For example, as shown in FIG. 8B, the device, or head unit 700 may retrieve data from the drive unit 100 and/or power meter 77, such as rider applied torque, motor torque, rider pedaling cadence, and/or motor temperature. Such data transmitted to the head unit 700 may identify how much torque the rider is currently putting into the system and how much energy the motor is applying to the system, and such information may help the method compensate for the amount of energy the user is providing. The total torque applied to the system may be used to estimate how much electrical energy will be needed.

Alternatively, or in addition, some of that data may be supplemented with data from additional sensors, such as cadence sensor 820 and rear derailleur 37, which may provide data about cadence and gearing information, which in turn can be used to calculate an expected or theoretical speed in real time. Similarly, the head unit 700 may retrieve data from the energy storage device, or battery 102, such as a current state of health and state of charge of the battery, a battery temperature, a discharge current, and a state of charge.

Battery factors evaluated by the head unit 700 may include a battery drain analysis, including data on discharge current, which can be used to assist in determining expected discharge time given a battery's history. Data may further include an overall state of health in view of battery age and performance degradation. Such information may assist the methods described in derating the battery over a lifespan. The data may further include battery temperature, also used to anticipate derating, as well as a current state of charge, which may be used with historical data and other system data, discussed below, to determine range in a current scenario.

Additional data may be retrieved by the device 700 to be included in both the bicycle range data (at 850) and the distance to destination data (at 860). For example, data retrieved from a GPS module and/or satellites 770, either taken alone or in combination with mapping and position determining modules 750 may be utilized for evaluating both range data and distance to destination data, as discussed in more detail below. Further, additional external data may be stored in an external database 725 or in system memory 720 defining rider data, bicycle weight, tire type, and current suspension state, as well as a currently selected drive mode, and, in some embodiments, historical data, either for a current user, or for a current trail, location, or other comparable aspect of current usage. In some embodiments, additional rider data, including biometric data, such as heart rate, calories burned, tiredness, and rider weight may be utilized as well. Rider weight and bicycle weight, for example, may be used to calculate an amount of energy required to move the system due to increased mass. Tire type may be used to evaluate frictional losses due to style as well as weight factors, suspension state may be used to determine related energy losses, and powertrain losses may be extracted from the data or independently provided. Current speed, either determined based on cadence and gearing information or extracted from GPS data, may be used to estimate expected energy requirements.

The device 700 may further control and consider a selected assist level or other ride mode. The desired assist level may be used to calculate how much assistance the rider would like to have, and as discussed in more detail below, may be controllable from or by the head unit to automatically compensate for energy use or to prioritize additional assist during climbing a grade.

Data from the drive unit 100 may further include motor temperature, which may allow for performance derating and for evaluation of a potential need to reduce motor torque to continue providing power over a defined route.

Historical data may be utilized in various ways, and may include power data from previous rides executed by the current user. Data from the head unit 700 and/or various system components may be uploaded to external networks 790, such as cloud services, which may be done in real-time or after a ride for analysis. Such data may include recorded biometric data as well. Historical data may further include “community” data, or data from other riders. As discussed below, such data may include power data from previously logged riders, and it may be utilized by the methods described herein if determined to be comparable in some way to the current user or a current use case. For example, if power data from a previously logged rider is for a ride on the same path the current user is utilizing. Such power data may require normalization if the data is comparable along certain dimensions (i.e., the same path) but distinct along other dimensions (i.e., gender, weight, actual power output by user, or fitness level).

In some embodiments, analysis is performed by the device 700 itself, while in other embodiments, data may be sent to a network 790 or cloud system for analysis.

Once both the bicycle range data and the distance to destination data are acquired, the method proceeds to compare (870) the remaining powered bicycle range (defined at 855) to the remaining distance to destination (865), and proceeds to generate a visualization (880) comparing the powered bicycle range data to the distance to destination data, either in raw form or in terms of the remaining powered bicycle range and distance to destination represented thereby. Such a visualization may then be presented (890) to a user at the user interface 730 of the user interface device 700.

In some embodiments, the method implements the method described iteratively. Accordingly, the method may repeatedly retrieve powered bicycle range data (at 850) and define the remaining powered bicycle range (at 855) and determines or acquires distance to destination data (at 860) and define the remaining distance to destination (at 865) in order continuously update the comparison and resulting visualization. In some embodiments, the comparison (at 870) is processed internally, and the method displays an indication (such as the visualization presented at 890) upon determining (at 875) that the remaining powered bicycle range represented by the range data is less than the remaining distance to the destination represented in the distance to destination data. If the remaining range is greater than the remaining distance, the method may then proceed to repeatedly determine the current location (at 856) and retrieve updated range data (at 850) in order to repeatedly update the comparison (at 870).

In some such embodiments, the visualization is a display or color change of a user interface element presented to a user. As such, the user interface device 700 may present a standard navigation interface, and upon determining that the remaining powered bicycle range is insufficient for the remaining distance to the destination, a display element may change color, such as an indicator turning red, or an indicator light may be activated. Similarly, the visualization discussed below may be presented and may replace a portion of the display at the user interface 730.

In other embodiments, the visualization (generated at 880) may be selected for display by a user, such that it is presented to the user during their usage of the user interface device 700. In such an embodiment, the reduction of the remaining powered bicycle range below the remaining distance to destination may not result in a change, or it may change an interface color, such that some portion of the display turns red, for example.

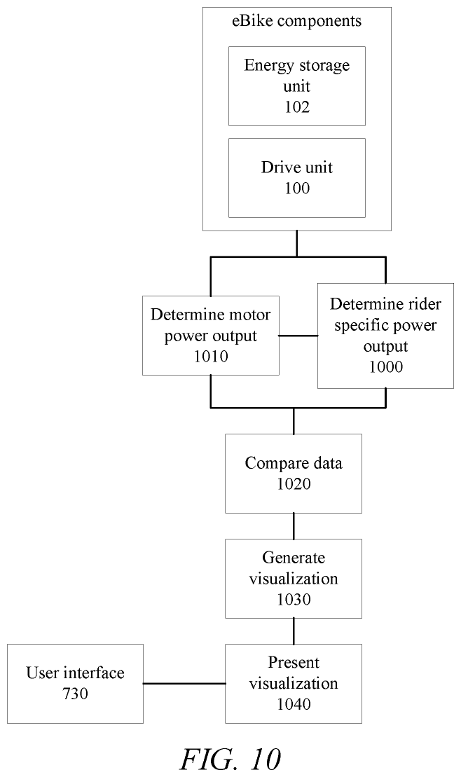

FIGS. 9A-C illustrate examples of a visualization 900 (generated at 880). In the embodiment shown, the visualization generated (at 880) presents a first user interface element 910 with a characteristic based on the bicycle range data (retrieved at 850) and a second user interface element 920 with a corresponding characteristic based on the distance to destination data (retrieved at 860).

The characteristic is typically a size parameter, such as a width 930, 940 of the corresponding element and that parameter is maintained at a size proportional to the corresponding underlying data. Accordingly, the first user interface element 910 may have a width 930 proportional to the remaining bicycle range and the second user interface element 920 may have a width 940 proportional to the remaining distance to the destination.

In the embodiment shown, the method may be performed iteratively, as discussed above, such that the visualization is updated for each iteration. The first user interface element 910 and the second user interface element 920 may be arranged linearly, and a total width 950 of the visualization 900 comprising the two interface elements 910, 920 combined may be maintained consistently across repeated iterations of the visualization.

Accordingly, while the total width 950 is maintained consistently, the width 930 of the first user interface element 910 and the width 940 of the second user interface element 940 are updated repeatedly and thereby change across repeated generating of the visualization in response to changes in the underlying values. The sizes of the first user interface element 910 and the second user interface element 920 therefore visually represent a repeatedly updated ratio of remaining powered bicycle range (850) to the remaining distance to the destination (860).

As noted above, the visualization 900 presented may be color coded. As such, in some embodiments, if the range remaining is equal to or less than the remaining distance to destination, the first user interface element 910 may be presented in red. Alternatively, if the range remaining is greater than the remaining distance to destination, the first user interface element 910 may be presented in green. The second user interface element 920 may then be consistently presented in a neutral color, such as yellow.

During use, both the remaining powered bicycle range and the remaining distance to the destination will decrease, as a user rides towards their destination and simultaneously depletes the energy in the energy storage device 102. Accordingly, by viewing the visualization 900 described herein, a user can easily determine whether they have sufficient remaining powered bicycle range even while the underlying values are dynamic.

FIG. 9A shows a sample readout demonstrating a distance remaining of about twice the battery capacity under current circumstances. FIG. 9B shows a sample readout demonstrating a distance remaining equal to the battery's capacity under current circumstances. FIG. 9C shows a sample readout demonstrating a distance remaining substantially shorter than the battery's capacity under the current circumstances.

Returning to the method of FIG. 8A, the distance to the destination data (determined or retrieved at 860) may be retrieved from an external device or determined internally. In the embodiment shown, it is determined internally and may be based on a predefined destination. Accordingly, the method receives a predefined destination, or a user defines such a destination (at 853). Such a destination may be indicated by the user at the user interface 730. The user interface device 700 may then determine a currently location (at 856), such as by utilizing a position determining module 750. The device 700 may then implement a mapping routine in order to determine (at 860) the data associated with a route from the current location to the destination, as well as a resulting distance to the destination. The method then defines a remaining distance to the destination (at 865) based on the determined data.

In some embodiments, the method may not be provided with a predetermined destination. Instead, a destination may be inferred based on a likely travel path, and such an inferred destination may be continuously updated based on a user's previous travel. The distance to destination data may then be based on the likely travel path.

In some embodiments, the powered bicycle range data (retrieved at 850) is processed further by the device 700 prior to defining the remaining powered bicycle range (at 855) and proceeding with the comparison (at 870). Accordingly, the variety of data acquired by the device 700 and included in the powered bicycle range data (at 850), as discussed above in reference to FIG. 8B may be leveraged in a variety of ways.

In some embodiments, the device 700 receives, from the energy storage device 102 a projected powered bicycle range which can be used directly. In some embodiments, the device 700 instead receives an indication of remaining energy, such as in terms of watt-hours remaining. The system may then extrapolate from such minimal powered bicycle range data a remaining powered bicycle range based on parameters stored in the memory 720 of the user interface device 700. For example, the method may have a conversion factor based on a known miles per watt-hour rating for the combination of bicycle 50, energy storage device 102, and drive unit 100. Such a conversion factor may further consider additional data retrieved or generated at the user interface device 700. For example, where the user interface device 700 generates a route, either in determining the distance to destination or independently of the methods discussed herein, the method may consult such a planned route in order to determine any characteristics of the route, such as hills or road surface textures, which may impact power usage and resulting range.

In some embodiments, the powered bicycle range data may be based at least partially on the grade or surface texture expected for the route (or for a current location, if no route is defined), or a segment of the route as defined by the mapping and position determining module 750. Such data may be extracted from GPS data 770 or mapping data, and may consider local elevation changes. An external lookup at a database 725 or other external network 790 may be utilized to acquire additional riding surface information, such as whether a surface is gravel, pavement, or dirt. Similarly, equipment factors associated with a bicycle utilized for implementing the method may be retrieved from a database 725, and the powered bicycle range data may also include bicycle weight, tire type, or a current suspension state of the bicycle. Similarly, biometric data may be maintained at the device memory 720 or in the database 725, and the bicycle range data may further depend on rider weight or the rider's overall state of fitness, as well as the rider's history of performance. Environmental conditions, such as local weather, temperature, wind speed, or humidity, at a location of the bicycle may be retrieved from a network 790, the device 700 itself, or sensors external to the device, and hardware factors from the battery 102 and the drive unit 100 may be included in the data retrieved (at 750). Accordingly, in determining the remaining powered bicycle range, the methods described herein may determine an expected energy consumption as a sum a desired power level of the system (i.e., power assist level of the drive unit), environmental losses, bicycle hardware or other equipment losses, and, in some cases, biometric data.

In some embodiments, in addition to route-based data, the conversion factor may consider rider contributions. As such, the powered bicycle range data may be based on a user pedaling, and may therefore assume that the bicycle will be driven both by the drive unit 100 and the user pedaling. A projected range based on both power remaining and a projected contribution of rider power is therefore greater than a battery only powered bicycle range. Such a projected rider contribution may then be based on historical data corresponding to a specific rider, such as data indicating how hard the rider typically pedals. Accordingly, in the context of the calculated remaining powered bicycle range, the expected energy consumption discussed above may further subtract any applied rider power. Accordingly, range calculations, whether considered in the context of a specific route or without a route may be based on the various data categories discussed above, including rider and bicycle weight, battery state, environmental conditions, and historical user data.

In some embodiments, the conversion factor may incorporate elements separately derived from historical data of a particular ride. For example, a projected rider contribution may assume a continuing contribution from a user based on a rolling average over a period of time prior to the retrieving of powered bicycle range data. Such a rolling average may be based on real time power output from the rider retrieved from a power meter device 77 or from a power meter integrated into the drive unit 100.

Typically, in such embodiments, where the user contribution is considered in determining the powered bicycle range data, where the method continuously updates the underlying data, the method may similarly update the rolling average of the user contribution. As such, the visualization (generated at 880) may be based on updated powered bicycle range data which itself depends on an updated projected contribution of rider power.

The projected contribution of rider power is retrieved or determined as part of the powered bicycle range data (at 850) or is considered in the definition of the resulting remaining powered bicycle range (at 855). The projected contribution of rider power may be based at least partially on biometric data of the rider. This may be data retrieved from a database 925, including rider weight, age, gender, or the like, or it may be inputted by the rider at the device 700. In some embodiments, the biometric data may be inferred from historical riding data associated with the specific rider currently using the device 700.

In some embodiments, the projected contribution of rider power may be based at least partially on historical data based on historical bicycle riders in comparable riding scenarios. For example, the projected contribution of rider power may be extracted from a database of system users who previously rode on the same or similar routes, or on similar road textures, similar road grades, or any combination of factors that might render such historical data analogous. In some such embodiments, the historical data associated with other riders may be normalized based on biometric data of the current user of the system, such that historical data may be filtered based on users having similar physical characteristics or at similar levels of fitness, or historical data may be adjusted to reflect the current rider biometric characteristics.

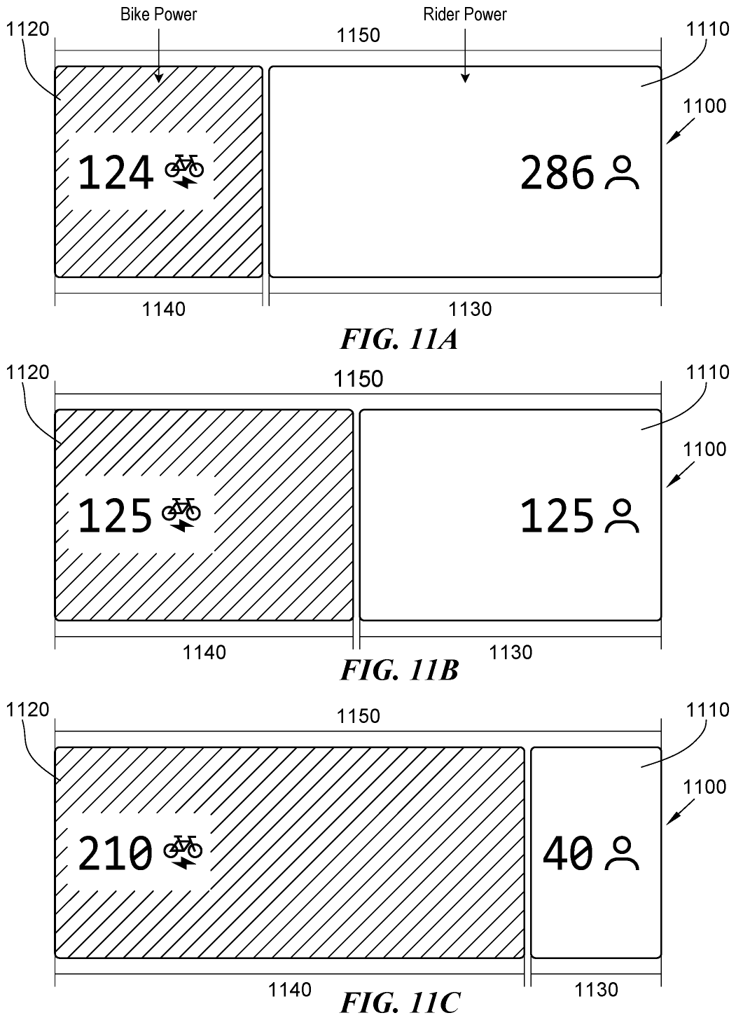

FIG. 10 is a flowchart illustrating a method for monitoring bicycle power output in accordance with this disclosure. The method shown is similar to that discussed above with respect to FIG. 8, and generates a similar visualization. However, the visualization may be based on different underlying data.

Accordingly, the method first determines a rider specific power output (1000). Such rider specific power output may be retrieved from a power meter device 77, as discussed above. The method may then determine a motor power output (1010), which determination may be based on data retrieved from the energy storage unit 102 or the drive unit 100 or otherwise derived. For example, as noted above, the eBike components, such as energy storage unit 102 and drive unit 100, may cast data over the Light Electric Vehicle profile of the ANT+radio signal or a Bluetooth radio signal. The eBike components may then cast both “rider power” and “% of total power” data. The rider power data may then be retrieved while the motor power may then be derived.

The method then compares the rider specific power output to the motor power output (1020) and generates (1030) a visualization comparing the rider specific power output to the motor power output. The visualization is then presented (1040) to a user.

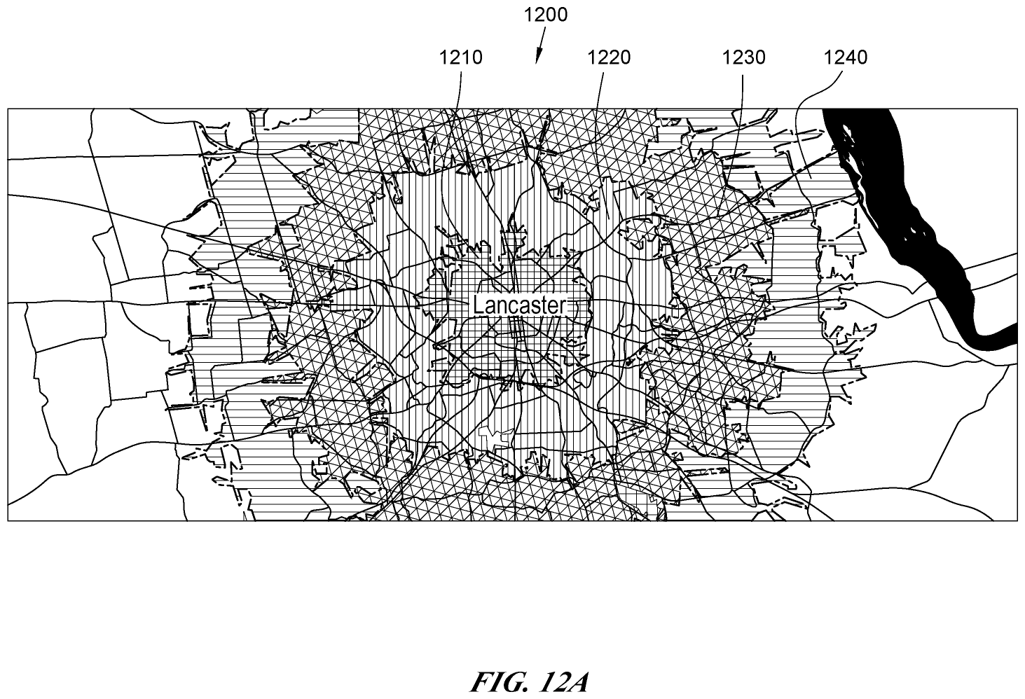

An example of such a visualization 1100 is shown in FIGS. 11A-C. As discussed above, the visualization 1100 generated (at 1030) presents a first user interface element 1110 with a characteristic based on the rider specific power output (retrieved at 1000) and a second user interface element 1120 with a corresponding characteristic based on the motor power output (retrieved at 1010).

The characteristic is typically a size parameter, such as a width 1130, 1140 of the corresponding element and that parameter is maintained at a size proportional to the corresponding underlying data. Accordingly, the first user interface element 1110 may have a width 1130 proportional to the rider specific power output and the second user interface element 1120 may have a width 1140 proportional to the motor power output.

In the embodiment shown, the method may be performed iteratively, as discussed above with respect to the method of FIG. 8, and the visualization is updated for each iteration. The first user interface element 1110 and the second user interface element 1120 may be arranged linearly, and a total width 1150 of the visualization 1100 comprising the two interface elements 1110, 1120 combined may be maintained consistently across repeated iterations of the visualization.

Accordingly, while the total width 1150 is maintained consistently, the width 1130 of the first user interface element 1110 and the width 1140 of the second user interface element 1140 are updated repeatedly and thereby change across repeated generating of the visualization in response to changes in the underlying values. The sizes of the first user interface element 1110 and the second user interface element 1120 therefore visually represent a repeatedly updated ratio of rider specific power output to the motor power output.

FIG. 11A shows a sample readout demonstrating a rider contributing more power than the eBike drive unit 100. FIG. 9B shows a sample readout demonstrating a rider and drive unit 100 contributing equally. FIG. 9C shows a sample readout demonstrating a drive unit 100 contributing more power than the rider.

The rider specific power output may be a real-time or substantially real-time measure of the metric, or it may be based on a rolling average of the determined rider specific power output over a specified period of time, such as a 3, 10, or 30 second average.

In some embodiments, the motor power metric isn't directly retrieved from the energy storage unit 102 or the drive unit 100. Instead, the motor power output may be determined (at 1010) based on the rider specific power output (determined at 1000) and a metric for percentage of total power represented by the ride specific power output.

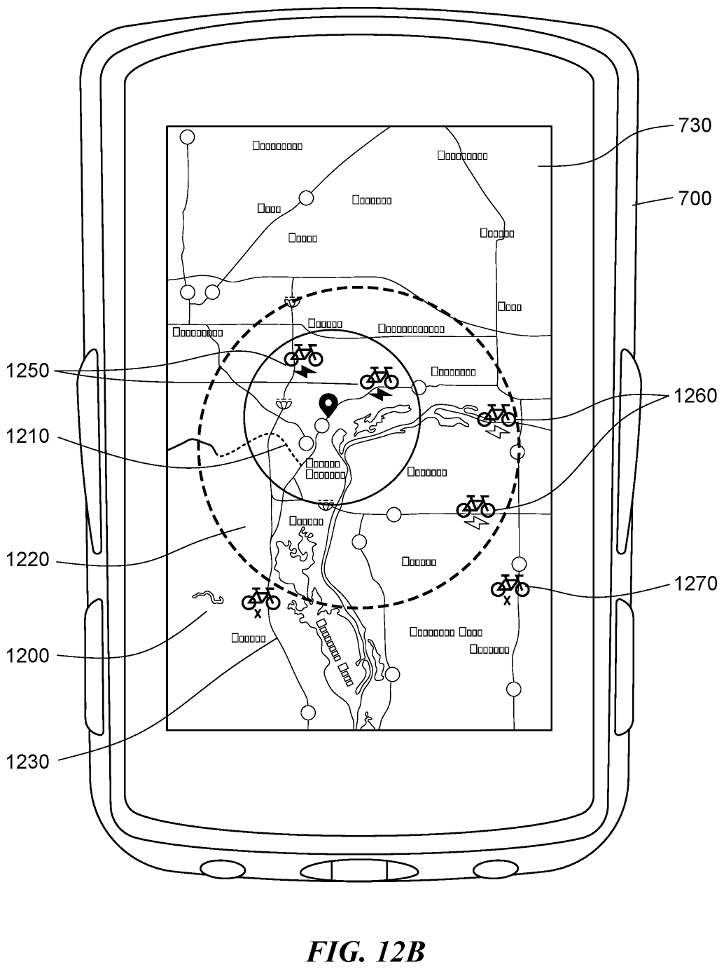

FIGS. 12A and 12B illustrate an alternative visualization generated by the methods of FIG. 8A. As shown in FIG. 12A, the visualization generated by the method (at 880) may include a map 1200 presenting hypothetical destinations, where the method highlights all destinations of the hypothetical destinations within the remaining powered bicycle range (determined at 855). The visualization may then present the map with a primary zone 1210 reachable using the calculated range.

In some embodiments, the visualization may present the map with secondary 1220 and tertiary 1230 zones representing ranges longer than the calculated range. For example, the primary zone 1210 may represent a range of the bicycle using battery power assuming no contribution from a rider, while the secondary 1220 and tertiary 1230 zones may represent range with different amounts of rider effort assumed. Additional extended range zones 1240 may be illustrated as well.

In some embodiments, rather than evaluating range based on rider power contributions, the method may evaluate based on expected levels of motor assist. The visualization may then similarly present the map 1200 with the nested zones 1210, 1220, 1230, and 1240 representing different levels of assist associated with different assist modes of the drive unit 100.

FIG. 12B illustrates such a map 1200 presented in the context of a user interface 730 of a device 700. As shown, hypothetical destinations 1250, 1260, 1270, represented by bicycles, as shown in three distinct zones 1210, 1220, 1230. As discussed in reference to FIG. 12A, the zones may correspond to anticipated rider contributions or drive unit 100 assist levels. Alternatively, the zones 1210, 1220, 1230 may correspond to thresholds associated with a desired remaining battery level. Accordingly, the hypothetical destinations 1250 in the primary zone 1210 may be reachable with greater than a threshold battery level remaining. For example, the threshold battery level may be 50%, allowing for a return trip, or it may represent some critical level, or it may be user selectable. The secondary zone 1220 may then contain hypothetical destinations 1260 reachable using the drive unit 100, but which would result in a battery depleted below the threshold. The tertiary zone 1230 may then contain hypothetical destinations 1270 reachable only with a fully depleted battery.

The user interface 730 illustrated in FIG. 12A may be implemented where no destination has been selected by a user of the device 700.

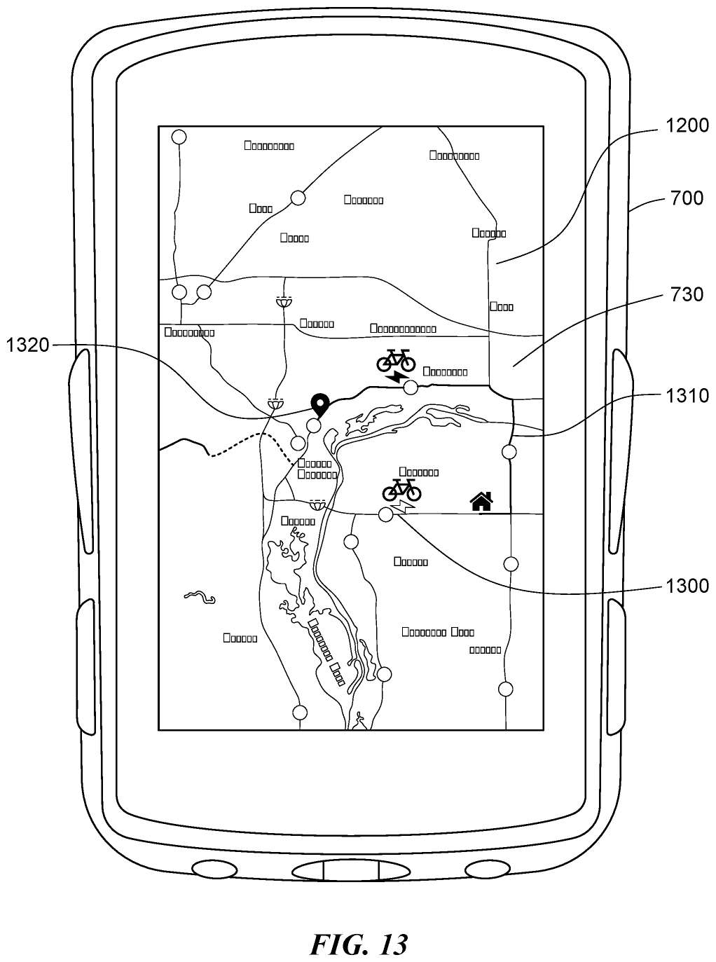

FIG. 13 shows a user interface device 700 implementing a portion of the method of FIG. 8A. As discussed above, in some embodiments, a remaining distance to destination defined (at 865) based on the underlying data (retrieved at 860) is based on a predefined destination 1320. The remaining powered bicycle range defined (at 855) based on the underlying data (retrieved at 850) may then be at least partially based on characteristics of the route itself, such as grade or surface texture.

In some such embodiments, the remaining distance to the destination 1320 is then based on a primary route 1300 initially determined by a mapping module as discussed above. The remaining powered bicycle range is then based on the powered bicycle range data which is, in turn extracted to an extent from data associated with the primary route. The method may then define and evaluate at least one alternative route 1310 based on alternative powered bicycle range data associated with the alternative route and defined by the mapping module. Accordingly, the underlying route data, such as grade or surface texture, may differ and thereby result in different resulting remaining powered bicycle ranges.

The method may then proceed to generate a recommendation of the alternative route 1310 upon determining that the alternative powered bicycle range data generates an alternative remaining powered bicycle range value that is larger than that of the powered bicycle range data based on the primary route. In other words, if the alternative route generates a range prediction larger than the primary route, the method may recommend switching to the alternative route.

Similarly, the method may generate a recommendation if the alternative remaining powered bicycle range associated with the alternative route 1310 represents a larger percentage of the alternative route than the remaining powered bicycle range associated with the primary route 1300 represents of the primary route. In other words, if switching routes will allow a user to travel farther along their route without depleting their power source, the method may generate such a recommendation.

Accordingly, where a rider defines a destination 1320 but not route, the method may evaluate throughout the ride if the current state of the system is sufficient to arrive at the selected destination, or if the rider should instead modify or shorten their ride.

Similarly, if a user has a desired destination 1320 and a preferred primary route 1300, the method may generate recommendations based on estimated range remaining. As discussed above, the method may create a cycling specific eBike draining cost which may use a variety of weighted factors, including grade, surface type, rider weight, assist level, and other factors to compute battery consumption along the primary route 1300. The combined data may then recommend alternative routes 1310 in order to shorten or modify the route or avoid climbs.

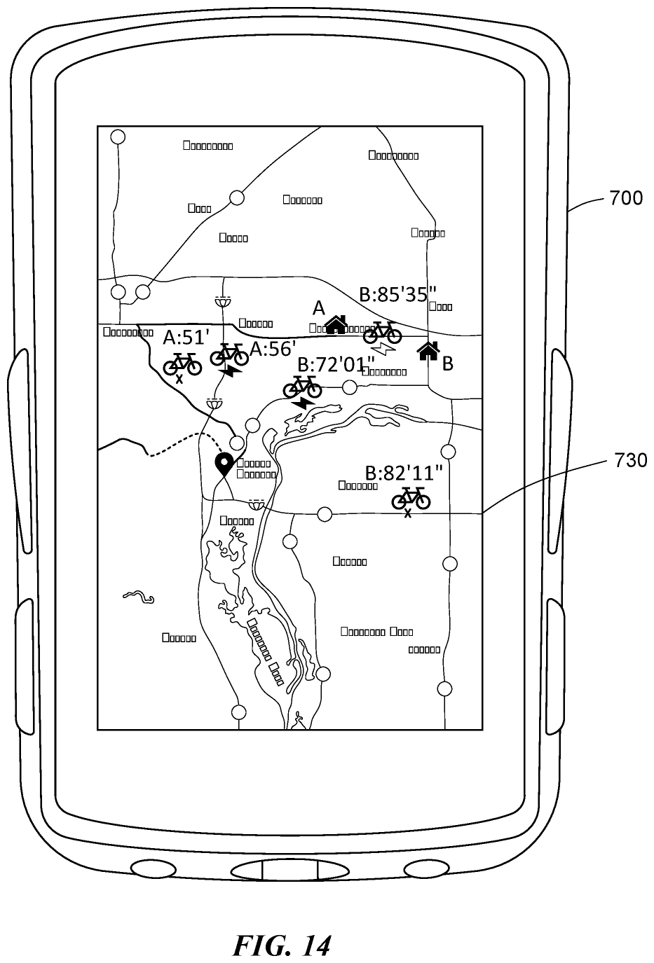

FIG. 14 shows a user interface device 700 implementing a portion of the method of FIG. 8A. As shown in the visualization presented, the method may present multiple routes 1400a, b, c to a proposed destination 1410. The multiple routes 1400a, b, c may be initially presented to users based on time as a core metric, but may be further sorted, or the sorting may be modified, based on battery cost, evaluated in a similar manner to the previously discussed implementations.

While several visualization options are shown in the figures, alternative visualizations are contemplated as well. Such alternative visualizations may include, for example, use of bars, color, sound, and others.

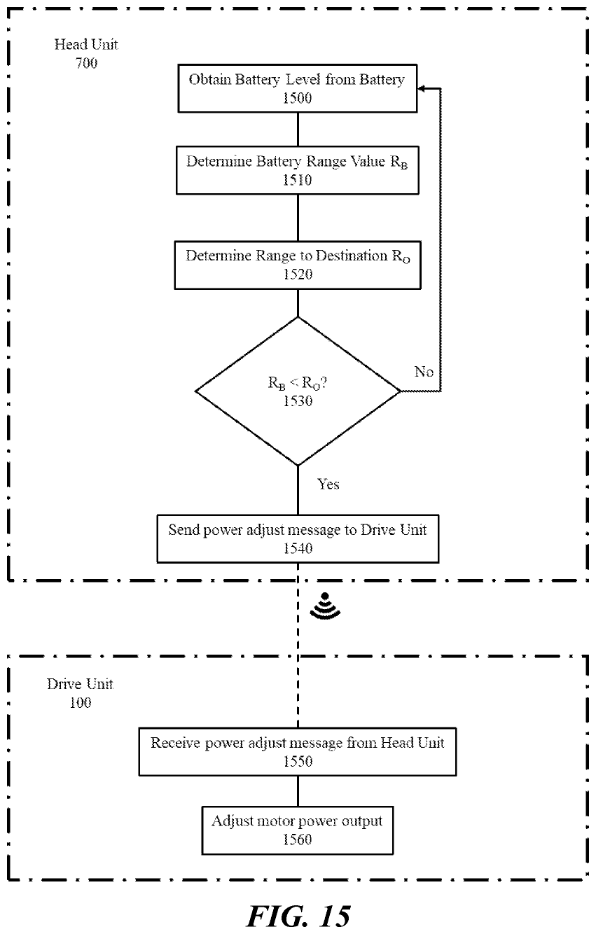

FIG. 15 illustrates a method for modifying hardware system settings in the context of the method of FIG. 8A. As discussed above, in some embodiments, a remaining distance to destination defined (at 865) based on the underlying data (retrieved at 860) is based on a predefined destination. The remaining powered bicycle range defined (at 855) based on the underlying data (retrieved at 850) may then be based on a wide variety of factors, and may be utilized to determine if a remaining powered bicycle range is greater than a distance to a destination.

Among factors that may be utilized to determine the remaining powered bicycle range (at 855) may be an assist mode associated with the drive unit 100. The drive unit 100 may then have a plurality of potential assist modes that a user or the system itself may select from.

The device 700 may then initially be provided in a first assist mode of a plurality of assist modes, and the method may obtain a battery level (at 1500) from an energy storage unit 102. The method may then utilize the battery level to determine a remaining powered bicycle range (1510), where the determination is at least partially based on the first assist mode. The method may then determine or calculate a remaining distance to the identified destination (1520).

If the calculated distance to the identified destination is less than the remaining powered bicycle range in the current assist mode (at 1530), then the method may proceed iteratively by repeatedly confirming the current battery level (at 1500). However, if the remaining powered bicycle range is less than the remaining distance to the identified destination (at 1530), the method may transition the drive unit to a second assist mode different from the first mode. As noted above and as shown, e.g., in FIG. 8C, the head unit 700 may then transmit a message (1540) to the drive unit 100 in order to adjust a power or assist mode of the drive unit.

The drive unit 100 may then receive the message (at 1550) and adjust motor power output (1560) in response. In such an embodiment, the second assist mode provides a reduced drive unit output relative to the first assist mode.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

Further, in some embodiments of the present invention, some or all of the method components are implemented as a computer executable code. Such a computer executable code contains a plurality of computer instructions that when performed in a predefined order result with the execution of the tasks disclosed herein. Such computer executable code may be available as source code or in object code, and may be further comprised as part of, for example, a portable memory device or downloaded from the Internet, or embodied on a program storage unit or computer readable medium. The principles of the present invention may be implemented as a combination of hardware and software and because some of the constituent system components and methods depicted in the accompanying drawings may be implemented in software, the actual connections between the system components or the process function blocks may differ depending upon the manner in which the present invention is programmed.

The computer executable code may be uploaded to, and executed by, a machine comprising any suitable architecture. Preferably, the machine is implemented on a computer platform having hardware such as one or more central processing units (“CPU”), a random access memory (“RAM”), and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The functions of the various elements shown in the figures may be provided through the use of dedicated hardware as well as hardware capable of executing appropriate software. When provided by a processor, the functions may be provided by a single dedicated processor, by a single shared processor, or by a plurality of individual processors, some of which may be shared. Explicit use of the term “processor” or “controller” should not be construed to refer exclusively to hardware capable of executing software, and may implicitly include, without limitation, digital signal processor hardware, processing circuitry, ROM, RAM, and non-volatile storage.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A computer-based method for monitoring bicycle range comprising:
determining a remaining powered bicycle range;
determining a remaining distance to destination;
comparing the powered bicycle range to the distance to destination; and
generating a visualization comparing the powered bicycle range to the distance to destination.

2. The method of claim 1, wherein determining the remaining powered bicycle range includes:
retrieving a powered bicycle range data; and
defining the remaining powered bicycle range to be at least partially based on the powered bicycle range data.

3. The method of claim 1, wherein determining the remaining distance to a destination includes:
acquiring a distance to destination data; and
defining the remaining distance to a destination to be at least partially based on the distance to destination data.

4. The method of claim 1, wherein the method displays an indication upon determining that the remaining powered bicycle range is less than the remaining distance to the destination.

5. The method of claim 2, wherein the indication is the presentation of the visualization generated to a user or a display or color change of a user interface element in the context of the visualization.

6. The method of claim 1, wherein the visualization generated presents a first user interface element with a characteristic based on the remaining powered bicycle range and a second user interface element with a characteristic based on the remaining distance to destination, and wherein the characteristic of the first user interface element is a size characteristic proportional to the remaining bicycle range and the characteristic of the second user interface element is a size characteristic proportional to the remaining distance to the destination.

7. The method of claim 1, wherein the visualization generated includes a map presenting hypothetical destinations, wherein the method further comprises highlighting all destinations of the hypothetical destinations within the remaining powered bicycle range.

8. The method of claim 1, wherein the remaining distance to destination is based on a predefined destination, and wherein the method retrieves or determines a current location of a device implementing the method and calculates a distance to the predefined destination based on a mapping module and provides a result as the remaining distance.

9. The method of claim 8, wherein the remaining powered bicycle range is based at least partially on a grade or surface texture of at least a segment of a route defined by the mapping module, equipment factors associated with a bicycle utilized for implementing the method, environmental conditions at a location of the bicycle, or hardware factors associated with a drive unit or battery utilized by the bicycle.

10. The method of claim 9, wherein the remaining distance is based on a primary route, and wherein the remaining powered bicycle range is based on the powered bicycle range, and wherein the method further comprises defining and evaluating at least one alternative route based on alternative powered bicycle range data associated with the alternative route and defined by the mapping module, and generating a recommendation of the alternative route upon determining that the alternative powered bicycle range generates an alternative remaining powered bicycle range value that is either larger than that of the powered bicycle range data or represents a larger percentage of the alternative route than the remaining powered bicycle range represents of the primary route.

11. The method of claim 8, wherein the remaining powered bicycle range is based at least partially on a first assist mode of a drive unit associated with a bicycle utilized for implementing the method selected from a plurality of potential assist modes.

12. The method of claim 9, wherein upon determining that the remaining powered bicycle range is less than the remaining distance to a destination, transitioning the drive unit to a second assist mode of the plurality of potential assist modes different from the first assist mode, wherein the second assist mode provides reduced motor output relative to the first assist mode.

13. The method of claim 1, wherein a destination is inferred based on a likely travel path, and the remaining powered bicycle range is then based on the likely travel path.

14. The method of claim 1, wherein the remaining powered bicycle range is a projection based at least partially on an amount of power remaining combined with a projected contribution of rider power, such that the remaining powered bicycle range is greater than a battery only powered bicycle range.

15. The method of claim 14, wherein the projected contribution of rider power assumes a continuing contribution from a user based on a rolling average over a period of time prior to the determining of powered bicycle range.

16. The method of claim 15, wherein the method displays an indication upon determining that the remaining powered bicycle range represented by the powered bicycle range data is less than the distance to the destination represented by the remaining distance to destination, and wherein the method further comprises repeatedly determining updated powered bicycle range and determining or acquiring updated distance to destination data, and wherein the updated remaining powered bicycle range is based on a different period of time prior to the retrieving, such that the indication depends on an updated projected contribution of rider power.

17. The method of claim 14, wherein the projected contribution of rider power is based at least partially on historical data based on historical bicycle riders in comparable riding scenarios.

18. A system comprising:
a user interface device having a processor, a communication module, and a display, the user interface device being mounted on a bicycle;
an energy storage device mounted on the bicycle, the energy storage device having a communication module in communication with the communication module of the user interface device; and
a drive unit mounted on the bicycle and powered by the energy storage device, such that the drive unit applies a motive force to the propel the bicycle using energy from the energy storage device,
wherein the user interface device retrieves from the energy storage device powered bicycle range data and determines a remaining powered bicycle range based on the bicycle range data,
wherein the user interface device determines or acquires distance to destination data representing a remaining distance to a destination,
wherein the user interface device compares the powered bicycle range data to the distance to destination data and generates a visualization comparing the powered bicycle range data to the distance to destination data.

19. The system of claim 18 wherein the communication module of the user interface device and the communication module of the energy storage module are in wireless communication.

20. The system of claim 18, wherein the drive unit has a first configuration utilizing a first of a plurality of assist modes, and wherein the remaining powered bicycle range is based at least partially on the configuration of the drive unit, and wherein upon determining that the remaining bicycle range is less than the remaining distance to destination, the user interface device transmits an instruction to the drive unit by way of the communication module to transition the drive unit to a second configuration utilizing a second of the plurality of assist modes, wherein the second assist mode provides reduced motive force relative to the first assist mode.
